(19) United States
(12) Patent Application Publication
(10) Pub. No.: US 2010/0306663 A1
(43) Pub. Date: Dec. 2, 2010

(54) Sequential Clicked Link Display Mechanism

(75) Inventors: Hui Jiang, Austin, TX (US); Indran Naick, Cedar Park, TX (US); Rohit R. Sahasrabudhe, Austin, TX (US); Jeffrey K. Wilson, Austin, TX (US)

Correspondence Address: Greg Goshorn, P.C., 9600 Escarpment, Suite 745-9, AUSTIN, TX, 78749, US

(73) Assignee: INTERNATIONAL BUSINESS MACHINES CORPORATION, Armonk, NY (US)

(21) Appl. No.: 12/472,485

(22) Filed: May 27, 2009

(51) Int. Cl. G06F 3/00

(52) U.S. Cl. 715/738

(57) ABSTRACT

Provided is a method to facilitate screen navigation in conjunction with a web browser. Specifically, a navigation history documenter and display module (NHDD) is employed in conjunction with a web browser to enhance the functionality of the browser. Using static links, categorical-hierarchical web sites, search engines or any combination of the three, a user freely navigates through multiple web sites and particular locations within web sites. The NHDD maintains a record of the navigation path. In conjunction with the specific sites and materials included in the navigation path, the NHDD maintain a record corresponding to the relations among the points along the path. In response to a user input, the NHDD displays navigation history information related to the order in which the points along a navigation path were traversed. In one embodiment, the information is displayed as sequentially order markers overlaid on a web page.

### BACKGROUND

1. Technical Field

The claimed subject matter relates generally to a computer display and, more specifically, to a method for facilitating screen navigation within a web browser.

2. Description or the Related Art

When computers were first invented, programs and data were entered manually via a series of switches. Soon, entry of programs and data was performed either by means of punch cards or keyboards coupled to the computing devices. Certainly, one of the primary advances in the computing arts has been the introduction of the graphical user interface (GUI). A GUI enables a user to enter data and commands and to execute programs by means of a keyboard and a computer mouse.

Originally, computers were each a stand-alone machine employed for the execution of a specific task. One of the first improvements to this original architecture is the connection of computers into networks so that multiple machines could share peripheral devices such as data storage and printers. Eventually, thousands, if not millions, of computers became networked into what has become known as the Internet. The Internet enables information stored on a properly configured computer, or server, to be accessible to computer users around the world. Of course, as the Internet has grown in size, the difficulty of locating information relevant to a particular user has also increased.

A type of GUI specifically designed to facilitate interaction with the Internet is a web browser, or “browser,” that enables a user to navigate the Internet via the sequential display of selected web pages. A program that typically executes in conjunction with a web browser is a search engine, which is a program that enables a user to enter information, transmits the information to a server that searches the Internet for web pages that correspond to the entered information and then displays a search result that provides access points. or links, to the located web pages. A user “clicks” on a particular link to display the corresponding web page. Examples of navigation options provided by web pages include, but are not limited to, 1) static links scattered through a block of text; 2) categorical, hierarchical links; and 3) links in a result set returned by a search engine. Each option is described in more detail below.

With respect to static links scattered through a block of text, there may be no particular order in which a user traverses the links. The location of a link by a landmark, such as a graphic of some recognizable or memorable text, may make it easy for the user to remember a traversal order but often there is no easily remembered pattern corresponding to a navigation order.

With respect to categorical, hierarchical links, many web sites include multiple levels that a user must traverse to locate specific information. For example, a user may navigate to a web site associated with an online furniture store, which sells a number of products in several different categories, such as “clothing,” “furniture,” “sporting goods” and so on. If the user were interested in purchasing a table, the user would “click on” the furniture category and web site would may return with a number of categories associated with the types of tables carried by the retailer, i.e. “end tables,” “kitchen tables,” “utility tables,” “work tables” and so on. The use then “clicks on” the appropriate category to display the tables available in that category. In the alternative, the user may enter the term “kitchen table” into a search engine and immediately display the tables available in that particular category. In addition, the user may search a number of web sites associated with different stores to locate the appropriate table and further, during the search for a table, browse other products and categories that happen to catch the user's interest.

With respect to links in a result set returned by a search engine, a typical navigation technique is to navigate to a particular web page listed in the search result returned by the search engine, determine the relevance of the web page, return to the search result page and then navigate to another that web page in the search result. This process continues until the user locates the web page listed in the search result that most closely fulfills the search requirements. Unfortunately, a user often does not know which web page most closely satisfies the search requirements until several different locations have been scanned.

An issue with all three types of navigation is that the user may not remember how to navigate back to a previous result or the best web page. A web browser's “Back” button only returns to immediately preceding web pages and a “history” listing of the search does not include any information that relates to the exact path through the previously searched pages. Further, one difficulty associated with all three types of navigation is an inability of the user to remember a specific navigation order corresponding to the navigation. Whether using a static list, a search engine or a hierarchical websites, the user may locate a item that is of interest but continue to search for other material. At the point at which the user is satisfied that a complete search has been conducted, the user is unable to remember exactly how to navigate back to specific web sites associated with the relevant material or product.

### SUMMARY OF THE CLAIMED SUBJECT MATTER

Provided is a method to facilitate screen navigation in conjunction with a web browser. Specifically, a navigation history documenter and display module (NHDD) is employed in conjunction with a web browser to enhance the functionality of the browser. Using static links, categorical-hierarchical web sites, search engines or any combination of the three, a user freely navigates through multiple web sites and particular locations within web sites. The NHDD maintains a record of the navigation path. In conjunction with the specific sites and materials included in the navigation path, the NHDD maintain a record corresponding to the relations among the points along the navigation path.

In response to a user input, the NHDD displays navigation history information related to the order in which the points along a navigation path were traversed. In one embodiment, the information is displayed as sequentially order markers overlaid on a web page. In this manner, the user is able to more easily select specific points along the path to which to return. In the alternative, the navigation history is displayed as a hierarchical tree with some end points of the path rendered as leaves and points along the path that lead to other points displayed as branches.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE FIGURES

A better understanding of the claimed subject matter can be obtained when the following detailed description of the disclosed embodiments is considered in conjunction with the following figures, in which:

FIG. 1 is a computing system architecture that is employed to implement the claimed subject matter.

FIG. 2 is a block diagram of a Navigation History Documenter and Display module (NHDD), first introduced in FIG. 1, in more detail.

FIG. 3 is one example of a window displayed by the NHDD of FIGS. 1 and 2 showing a list type display structure.

FIG. 4 is a flowchart of a Setup NHDD process for implementing one aspect of the NHDD of FIGS. 1 and 2.

FIG. 5 is a flowchart of an Operate NHDD process for implementing the NHDD of FIGS. 1 and 2.

### DETAILED DESCRIPTION OF THE FIGURES

Although described with particular reference to a window and Internet system, the claimed subject matter can be implemented in any information technology (IT) system in which an easily reviewable navigation history is desirable. Those with skill in the computing arts will recognize that the disclosed embodiments have relevance to a wide variety of computing environments in addition to those described below. In addition, the methods of the disclosed technology can be implemented in software, hardware, or a combination of software and hardware. The hardware portion can be implemented using specialized logic; the software portion can be stored in a memory and executed by a suitable instruction execution system such as a microprocessor, personal computer (PC) or main frame.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic or semiconductor system, apparatus or device. Memory and recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

One embodiment, in accordance with the claimed subject, is directed to a programmed method for displaying a navigation history. The term “programmed method”, as used herein, is defined to mean one or more process steps that are presently performed; or, alternatively, one or more process steps enabled to be performed at a future point in time. The term “programmed method” anticipates three alternative forms. First, a programmed method comprises presently performed process steps. Second, a programmed method comprises a computer-readable medium embodying computer instructions, which when executed by a computer performs one or more process steps. Finally, a programmed method comprises a computer system that has been programmed by software, hardware, firmware, or any combination thereof, to perform one or more process steps. It is to be understood that the term “programmed method” is not to be construed as simultaneously having more than one alternative form, but rather is to be construed in the truest sense of an alternative form wherein, at any given point in time, only one of the plurality of alternative forms is present.

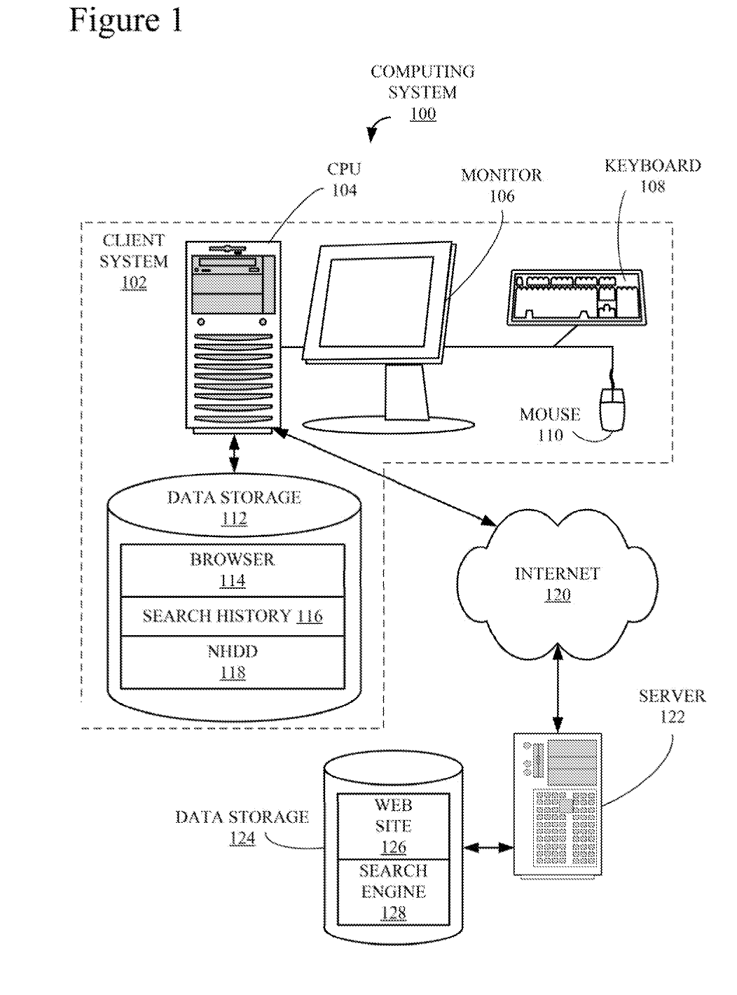

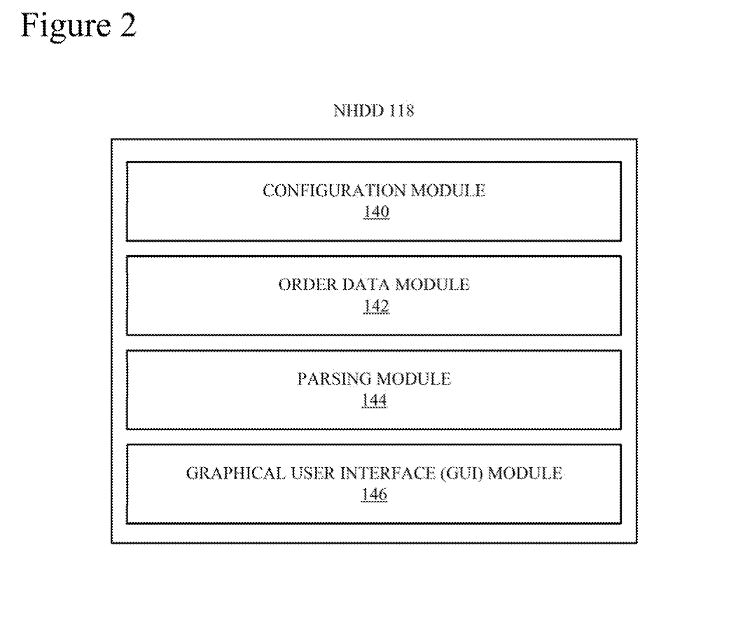

Turning now to the figures, FIG. 1 is one example of a computing system architecture 100 that is employed to implement the claimed subject matter. A client system 102 includes a central processing unit (CPU) 104, coupled to a monitor 106, a keyboard 108 and a mouse 110, which together facilitate human interaction with computing system 100 and client system 102. Also included in client system 102 and attached to CPU 104 is a data storage component 112, which may either be incorporated into CPU 104 i.e. an internal device, or attached externally to CPU 104 by means of various, commonly available connection devices such as but not limited to, a universal serial bus (USB) port (not shown). Data storage 112 is illustrated storing a web navigation application, or “browser,” 114. Browser 114 includes a search history 116. Browser 114 and search history 116 should be familiar to those with skill in the computing arts. Browser 114 is also illustrated in conjunction with a Navigation History Documenter and Display device (NHDD) 118. Although shown coupled to browser 114, NHDD 118 may also be deployed separately from browser 114 and is not specific to browser 114. In other words, NHDD 118 may be employed in conjunction with computer navigation devices other than a web browser. NHDD 118 is described in more detail below in conjunction with FIGS. 2-5.

Client system 102 and CPU 104 are connected to the Internet 120, which is also connected to a server computer 122. Although in this example, CPU 104 and server 122 are communicatively coupled via the Internet 120, they could also be coupled through any number of communication mediums such as, but not limited to, a local area network (LAN) (not shown). Server 122 is coupled to a data storage 124, which like data storage 102, may either be incorporated into server 122 i.e. an internal device, or attached externally to server 122 by means of various, commonly available connection devices such as but not limited to, a universal serial bus (USB) port (not shown). In this example, stored on data storage are a web site 126 and a search engine 128 associated with web site 126. Implementation and functionality associated with web site 126 and search engine 128 should be familiar to those with skill in the computing arts. It should also be noted there are many possible computing system configurations, of which computing system 100 is only one simple example.

FIG. 2 is a block diagram of a Navigation History Documenter and Display module (NHDD) 118, first introduced above in FIG. 1, in more detail. As explained above in conjunction with FIG. 1, NHDD 118 can be either a component of browser 114 (FIG. 1) or a separate component such as a plug-in module. NHDD 118 is stored in data storage 112 (FIG. 1) and executes on CPU 104 (FIG. 1).

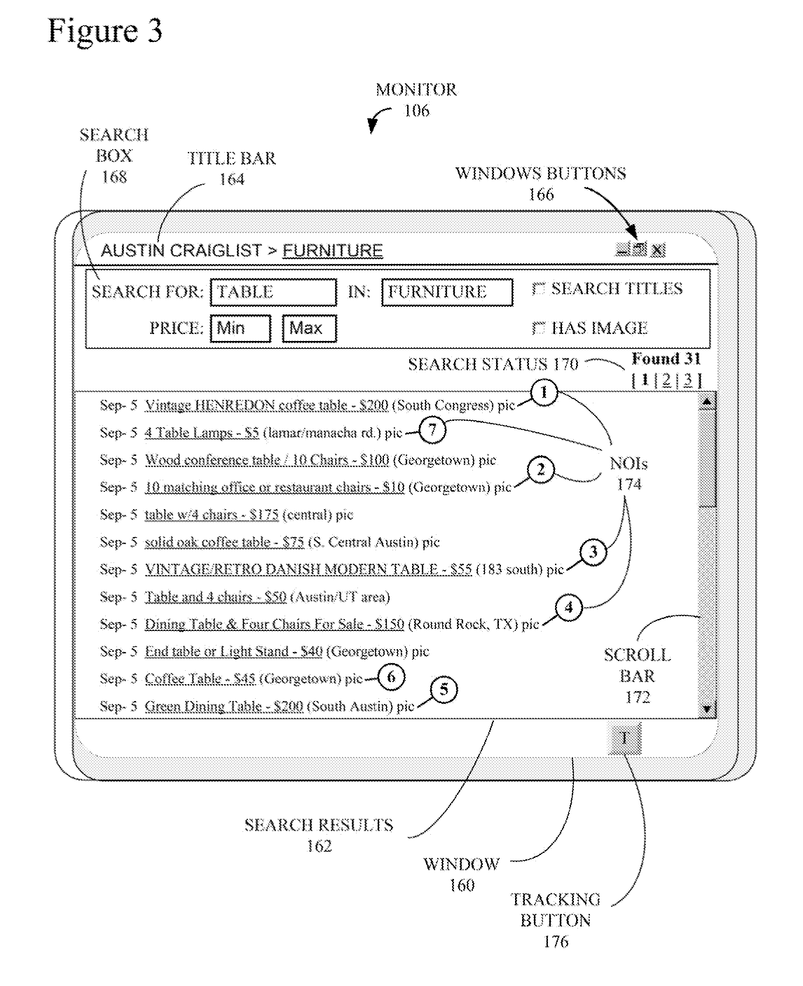

NHDD 118 includes a configuration module 140, an order data module 142, a parsing module 144 and a graphical user interface (GUI) module 146. Configuration module 140 stores parameters necessary for the operation of NHDD 118. Types of parameters include, but are not limited to, default displays, i.e. a list format (see FIG. 3) or a hierarchical format (not shown), a number of historical events to include in a display and whether or not to execute automatically in conjunction with browser 114 or to wait for user input before either execution or display of information.

Order data module 142 stores navigation information concerning web sites displayed by browser 114 and works in conjunction with history data 116 (FIG. 1). In other words, each time a user of browser 114 clicks on a particular screen, NHDD 118 stores data including, but not limited to, data identifying both the requested web page and the web page from which the request originated, i.e. the web page which included a clicked upon link for the requested page. Also included is information on the time at which each particular web page was retrieved and displayed. Those with skill in the computing arts should appreciate the many ways in which such information may be stored, such as memory objects associated with each web page and hierarchical trees showing the relationships among the objects.

Parsing module 144 includes logic for creating a hierarchical structure that represents the order and relationships among displayed web pages. In one embodiment, paring module 144 executes each time a new web page is requested by browser 114 so that the generated information is stored in history data module 142. In the alternative, parsing module 144 is executed when a user initiates NHDD 118 to display information relating to the displayed web sites. GUI module 146 interacts with browser 114 and history data 116 (FIG. 1) to display historical and hierarchical information related to web sites that have been displayed (see FIG. 3).

FIG. 3 is one example of a window 160 displayed by the NHDD 118 of FIGS. 1 and 2 showing a list type display structure. In this example, window 160 is displayed on monitor 106 (FIG. 1) and is illustrated as showing a search result 162. Search Result includes a title bar that indicates the current web site and a particular section of that web site, i.e. “Austin Craigslist” and “Furniture,” respectively. Also included in title bar 164 are various window buttons 166, which enable a user to minimize, maximize and close window 160. A search box 168 enables the user to enter criteria for limiting a particular search in window 160, which, in this example, the user is searching the “Furniture” section” of “Austin Craigslist” for “tables.” A search status indicator 170 displays information related to the current search, which, in this example, indicates the search located thirty-one (31) results and search result 162 is currently displaying the first of three pages of results. A scroll bar 172 enables the user to scroll additional results into search results 162 Those with skill in the computing arts should be familiar with windows, title bars, window buttons, search boxes, search status and scroll bars.

Also includes in conjunction with search results 162 are a number of navigation order indicators (NOIs) 174. For the sake of simplicity, all NOIs 174 of search results 162 are not labeled. NOIs 174 are generated by NHDD 118. NOIs 174 indicate to the user an order in which the various search results were navigated. In other words, NOI 172 displaying the number “1,” i.e. “Vintage HENREDON coffee table . . . ,” was the first search result that the user chose to examine, or click on. The search result “10 matching office or restaurant chairs . . . ” was the second link examined; the link “4 Table Lamps . . . ” was the seventh and so on.

In this example, NOIs 174 are either displayed or hidden when a user clicks on a tracking button 176. In other words, if NOIs 174 are not currently displayed, clicking button 176 displays them in window 160 and, if NOIs 174 are currently displayed, clicking on button 176 removes them from the window 160. In another embodiment, NOIs 174 are generated by NHDD 118 in response to a defined user input on client system 102 (FIG. 1) such as the pressing of a “hot key” on keyboard 108 (FIG. 1). In another embodiment, NHDD 118 is integrated with browser 114 (FIG. 1) such that NOIs 174 are automatically displayed in conjunction with any search result.

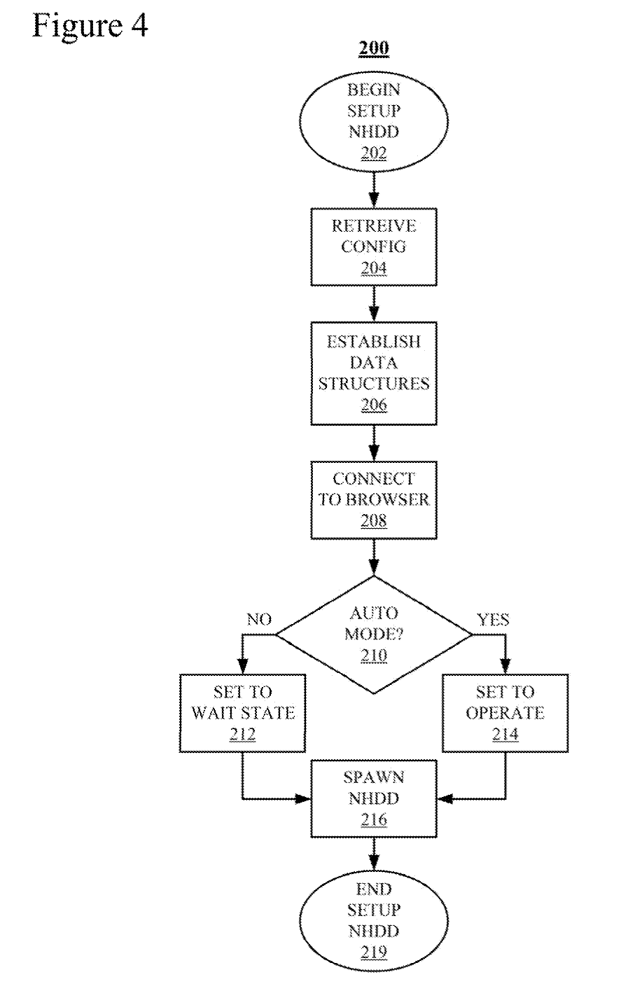

FIG. 4 is a flowchart of a Setup NHDD process 200 for implementing one aspect of NHDD 118 of FIGS. 1 and 2. In this example, process 200 is stored in data storage 112 (FIG. 1) and executes on CPU 104 (FIG. 1) of client system 102 (FIG. 1).

Process 200 starts in a “Begin Setup NHDD” block 202 and proceeds immediately to a “Retrieve Configuration (Config.)” block 204. During block 204, process 200 retrieves configuration parameters (see element 140, FIG. 2) that control the operation of process 200. Examples of options controlled by configuration parameters include, but are not limited to, a default browser, default displays, i.e. a list format (see FIG. 3) or a hierarchical format (not shown), a number of historical events to include in a display and whether or not to execute automatically in conjunction with browser 114 or to wait for user input before either execution or display of information.

During an “Establish Data Structures” block 206, process 200 sets up data structures associated with tracking the navigation of web sites. Examples of data stored include such information as web addresses, time and date stamps, information relating to a navigation order and a hierarchical order to accessed web sites. During a “Connect to Browser” block 210, process 200 attaches to the default browser by accessing a configuration option retrieved during block 204.

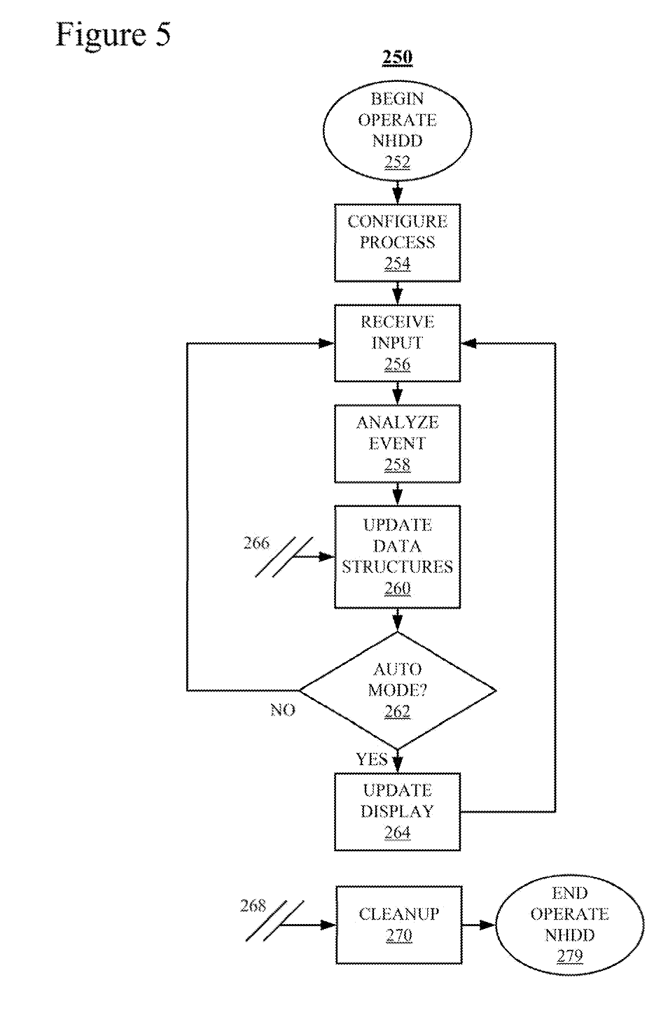

During an “Auto Mode?” block 210, process 200 determines whether or not the configuration parameters retrieved during block 204 indicate that navigation tracking, i.e. NOIs 174 (FIG. 3), should be automatically displayed or rather displayed when explicitly activated by the user, for example by clicking tracking button 176 (FIG. 3). In the alternative, the display may be activated or deactivated by a specified combination of “control,” “alt,” “function” and standard keys of keyboard 108 (FIG. 1). If block 210 determines that the display is not configured to operate automatically, control proceeds to a “Set to Wait State” block 214. In other words, process 200 sets a parameter so that when an Operate NHDD process 250 (see FIG. 5) is initiated the parameter is passed indicating NHDD 118 should collect information relating to screen navigation but not display NOIs 174 in conjunction with search results 162 (FIG. 3).

If, during block 210 process 200 determines that the relevant configuration parameter is appropriately set, process 200 proceeds to a “Set to Operate” block 216. During block 216, process 200 sets a parameter transmitted in conjunction with the initiation of process 250 indicating that NOIs 174 should be displayed.

Following completion of blocks 214 and 216, process 200 proceeds to a “Spawn NHDD” block 206, during which process 200 initiates Operate HNDD process 250. Finally, control proceeds to an “End Setup NHDD” block 219 during which process 200 is complete.

FIG. 5 is a flowchart of an Operate NHDD process 250 for implementing NHDD 118 of FIGS. 1 and 2. Like process 200 (FIG. 4), process 250 is stored in data storage 112 (FIG. 1) and executes on CPU 104 (FIG. 1) of client system 102 (FIG. 1). Process 250 starts in a “Begin Operate NHDD” block 252 and proceeds immediately to a “Configure Process” 254. During block 254, process 250 sets up operation in accordance with configuration parameters (see 204, FIG. 4) and parameters transmitted when process 250 is initiated (see 210, 212, 214 and 216, FIG. 4).

During a “Receive Input” block 256, process 250 waits for screen navigation events associated with window 160 (FIG. 3). During an “Analyze Event” block 258, parsing module (FIG. 2) of NHDD 118 (FIGS. 1 and 2) determines the type of event received during block 256 and determines an order and a position in a navigation hierarchy the location of the event. During an “Update Data Structures” block 258, the information calculated during block 258 is stored in Order Data Module 142 (FIG. 2).

During an “Auto Mode?” block 260, process 250 determines whether or not NHDD 118 is currently configured for display of NOIs 174 (FIG. 3). If so, during an “Update Display” block 262, GUI module 146 (FIG. 2) updates NOIs 174 in window 160. Following block 266 or, if during block 262 process 250 determines that NHDD 118 is not currently configured for display of NOIs 174, control returns to block 256 and processing continues as described above.

An asynchronous input 266 is generated if a user either clicks on tracking button 176 (FIG. 3) of enters a predetermined sequence of keys to indicate that NOIs 174 should be toggled on or off. In that event, control is interrupted from whatever point it currently executes and proceeds to Update Data Structures 260 during which the appropriate configuration parameters are updated and processing continues as described above.

Process 250 is halted by means of an asynchronous interrupt 268, which passes control to “Cleanup” block 270 during which any memory or other resources dedicated to process 250 are released. Finally, control proceeds to an “End Operate NHDD” block 279 in which process 250 is complete. Interrupt 268 is typically generated when the OS, browser, application, etc. of which process 250 is a part is itself halted or process 250 is explicitly halted as indicated by a predetermined sequence of key and mouse 110 inputs. During nominal operation, process 250 continuously loops through the blocks 256, 258, 260, 263 and 264, processing window events and user input sequences as generated.

While the claimed subject matter has been shown and described with reference to particular embodiments thereof, it will be understood by those skilled in the art that the foregoing and other changes in form and detail may be made therein without departing from the spirit and scope of the claimed subject matter, including but not limited to additional, less or modified elements and/or additional, less or modified blocks performed in the same or a different order.

We claim:

1. A method of controlling a screen display, comprising:
storing a history of screen navigation corresponding to a plurality of accessed documents;
calculating navigation order data, each datum of the data indicating an access order corresponding to a document of the plurality of documents;
correlating the navigation order data to a list of the accessed documents: and
displaying the list and the navigation order data such that each datum of the navigation order data is displayed in conjunction with the corresponding accessed document.

2. The method of claim 1, wherein the plurality of accessed documents are web pages.

3. The method of claim 2, further comprising incorporating the method in a web browser.

4. The method of claim 2, further comprising displaying a particular document of the plurality of accessed documents in response to a user input corresponding to a datum of the navigation order data corresponding to the particular document.

5. The method of claim 1, further comprising:
calculating hierarchical order data, relating to a navigation path associated with the plurality of documents, in conjunction with the navigation order data;
wherein the displaying represents both an order of navigation and the hierarchical order data.

6. The method of claim 5, wherein the hierarchical order data is represented in a tree structure.

7. The method of claim 1, further comprising:
enabling the displaying in response to user input; and
disabling the displaying in response to user input.

8. A system for controlling a screen display, comprising:
a memory;
a processor coupled to the memory;
logic, stored on the memory for execution on the processor, for:
storing a history of screen navigation corresponding to a plurality of accessed documents;
calculating navigation order data, each datum of the data indicating an access order corresponding to a document of the plurality of documents;
correlating the navigation order data to a list of the accessed documents; and
displaying the list and the navigation order data such that each datum of the navigation order data is displayed in conjunction with the corresponding accessed document.

9. The system of claim 8, wherein the plurality of accessed documents comprise web pages.

10. The system of claim 9, further comprising a web browser that comprises the logic stored on the memory for execution on the processor.

11. The system of claim 9, the logic, stored on the memory for execution on the processor, further comprising logic for displaying a particular document of the plurality of accessed documents in response to a user input corresponding to a datum of the navigation order data corresponding to the particular document.

12. The system of claim 8, the logic, stored on the memory for execution on the processor further comprising logic for:
calculating hierarchical order data, relating to a navigation path associated with the plurality of documents, in conjunction with the navigation order data;
wherein the displaying represents both an order of navigation and the hierarchical order data.

13. The system of claim 12, wherein the hierarchical order data is represented in a tree structure.

14. The system of claim 8, the logic, stored on the memory for execution on the processor further comprising logic for:
enabling the displaying in response to user input; and
disabling the displaying in response to user input.

15. A computer-readable storage medium for controlling a screen display, comprising:
a memory;
logic, stored on the memory for execution on a processor, for:
storing a history of screen navigation corresponding to a plurality of accessed documents;
calculating navigation order data, each datum of the data indicating an access order corresponding to a document of the plurality of documents;
correlating the navigation order data to a list of the accessed documents; and
displaying the list and the navigation order data such that each datum of the navigation order data is displayed in conjunction with the corresponding accessed document.

16. The computer-readable storage medium of claim 15, wherein the plurality of accessed documents comprise web pages.

17. The computer-readable storage medium of claim 16, further comprising a web browser that comprises the logic stored on the memory for execution on the processor.

18. The computer-readable storage medium of claim 16, the logic, stored on the memory for execution on the processor, further comprising logic for displaying a particular document of the plurality of accessed documents in response to a user input corresponding to a datum of the navigation order data corresponding to the particular document.

19. The computer-readable storage medium of claim 15, the logic, stored on the memory for execution on the processor further comprising logic for:
calculating hierarchical order data, relating to a navigation path associated with the plurality of documents, in conjunction with the navigation order data;
wherein the displaying represents both an order of navigation and the hierarchical order data.

20. The computer-readable storage medium of claim 15, the logic, stored on the memory for execution on the processor further comprising logic for:
enabling the displaying in response to user input; and
disabling the displaying in response to user input.
